(19) United States
(12) Patent Application Publication
(10) Pub. No.: US 2024/0007713 A1
(43) Pub. Date: Jan. 4, 2024

(54) PROVISION OF MEDIA CONTENT

(71) Applicant: BRITISH TELECOMMUNICATIONS PUBLIC LIMITED COMPANY, London (GB)

(72) Inventor: Jonathan RENNISON, London (GB)

(21) Appl. No.: 18/247,346

(22) PCT Filed: Sep. 20, 2021
(86) PCT No.: PCT/EP2021/075759

§ 371 Date: Mar. 30, 2023

(30) Foreign Application Priority Data
Sep. 30, 2020 (GB) 2015435.7

(51) Int. Cl. H04N 21/4728; H04N 21/2187; H04N 21/81; H04N 21/258; H04N 21/442; H04N 21/6405

(52) U.S. Cl. CPC H04N 21/4728; H04N 21/2187; H04N 21/816; H04N 21/25891; H04N 21/44218; H04N 21/6405

(57) ABSTRACT

Methods and apparatus are disclosed for providing media content to client devices configured to render received media content for displaying as a video presentation. In one aspect, the method includes providing a primary stream to the client devices including data corresponding to a full area of the media content when displayed as a video presentation on a client device, receiving field-of-view reports from respective client devices indicating a portion of the full area selected for viewing by a viewer, determining a common area of interest within the media content, and providing a supplementary stream to one or more of the client devices configured to include a subset of the primary stream selected in dependence on the common area of interest. If the common area of interest corresponds to a variable spatial area of the media content, the supplementary stream comprises data corresponding to the variable spatial area.

### PRIORITY CLAIM

The present application is a National Phase entry of PCT Application No. PCT/EP2021/075759, filed Sep. 20, 2021, which claims priority from GB Patent Application No. 2015435.7, filed Sep. 30, 2020, each of which is hereby fully incorporated herein by reference.

### TECHNICAL FIELD

The present disclosure relates to methods and apparatus for providing media content to receiver devices configured to render received media content. It relates in particular to scenarios in which the media content is or includes video content of the type referred to as “360° video” (also known as immersive video, omnidirectional video or spherical video).

### BACKGROUND

“360° video” is video which appears to “surround” the viewer at least partially, by means of a headset or otherwise. To provide “360° video”, a spherical view around a point in space (or a significant portion thereof) is captured as a video, generally using an omnidirectional camera or a collection of essentially co-located cameras facing in different directions, and is provided to client devices. Playback may be on a normal flat display such as that of a television, or a personal computer or smartphone or other mobile device on which the viewer may have control of the viewing direction or portion of the overall content that appears on the flat screen. The video images can also be played via a dedicated head-mounted display or other such headset worn by a viewer, or on a display arranged in a sphere (or part of a sphere) around the viewer. The display may be monoscopic (i.e. with the same images being directed at each eye, or in the case of headsets, in particular, stereoscopic (i.e. with separate images directed individually to each eye for a three-dimensional effect).

Client devices playing the video may play the complete sphere worth of content, but are generally able to display a subset of the captured sphere corresponding to a particular field-of-view, allowing the viewer to look at different parts of the overall content at different times or in response to points of interest within the overall content (chosen by or for the viewer) moving within the overall content. The parts selected for viewing may be based on eye-tracking or direction-of-gaze tracking, head-movements of the viewer, user-interface selection or on other selection mechanisms.

360° video is typically delivered in a single rectangular video stream mapped by equirectangular projection onto a field-of-view sphere around the viewer. The entire video stream can be delivered to client devices which then render a suitable subset of the overall content based on the currently-selected field-of-view at the client device in question.

As an alternative, the entire video stream can be statically divided into a grid of rectangular portions generally referred to as “tiles”, each of which is a smaller video stream. This technique is known generally as “tiled streaming” In this technique, client devices can receive the video stream tile(s) which cover(s), intersect(s) or overlap(s) with their current field-of-view. This generally reduces the bandwidth and client processing resources required by not transmitting parts of the entire video stream which are not in view.

With systems using tiled streaming, a process is generally needed to determine which tile(s) should be provided and to ensure that appropriate tiles are provided at appropriate times to a client device containing content corresponding to the part of the overall sphere required/desired by the viewer at any particular moment.

Referring to prior disclosures, a Working Draft from the International Organization for Standardization (ISO) entitled “WD on ISO/IEC 23000-20 Omnidirectional Media Application Format” edited by Byeongdoo Choi et al. dated June 2016 (available online at www.mpeg.chiariglione.org) defines a media application format that enables omnidirectional media applications, focusing on Virtual Reality applications with 360° video and associated audio. It specifies a list of projection mappings that can be used for conversion of a spherical or 360° video into a two-dimensional rectangular video, followed by how to store omnidirectional media and the associated metadata using the ISO base media file format (ISOBMFF) and how to encapsulate, signal, and stream omnidirectional media using dynamic adaptive streaming over HTTP (DASH), and finally which video and audio codecs as well as media coding configurations can be used for compression of the omnidirectional media signal.

A paper entitled “Analysis of 360° Video Viewing Behaviours” by Mathias Almquist and Viktor Almquist, published in 2018 and available online at www.semanticscholar.org discusses how a view-dependent streaming approach could allow for a reduction in bandwidth while maintaining a low rate of error if based on information about 360° viewing behaviors.

A paper entitled “Shooting a Moving Target: Motion-Prediction-Based Transmission for 360-Degree Videos” by Yanan Bao et al (December 2016) available online at www.web.cs.ucdavis.edu proposes a motion-prediction-based transmission mechanism that matches network video transmission to viewer needs. It proposes a machine-learning mechanism that predicts viewer motion and prediction deviation, the latter being said to be important as it provides input on the amount of redundancy to be transmitted. Based on such predictions, a targeted transmission mechanism is proposed that is said to minimize overall bandwidth consumption while providing probabilistic performance guarantees.

Referring now to prior patent documents, U.S. Pat. No. 10,062,414 (“Westphal”) entitled “Determining a Future Field of View (FOV) for a Particular User Viewing a 360 Degree Video Stream in a Network” relates to providing determined future FoVs of a 360 degree video stream in a network having multiple video streams corresponding to multiple FoVs. FoV interest messages including requests for FoVs at time instants of the video stream are collected from viewers of the stream. A sequence of popular FoVs is created according to the messages, each representing a frequently requested FoV at a distinctive time instant. FoV transitions are created according to the FoV interest messages, each FoV transition including a current FoV a time instant and a next FoV of a next time instant, indicating a likely next FoV to be requested. Future FoVs are determined for a user viewing the video stream with a history of requested FoVs of past time instants, based on the history of requested FoVs, the sequence and the transitions.

In some scenarios, and in particular (but not exclusively in relation to televised sport), viewers may be offered options to follow a particular person or object temporarily or permanently during a streamed event. Examples of scenarios in which such options may be offered include sports events in which a particular player, a coach or manager, an official or other character may be of particular interest to some viewers, in view of which content providers may offer a “player-cam”, “coach-cam” or “ref-cam” option, or sports events in which “ball-tracking” may be of interest to some viewers. In such scenarios, the areas of interest for a number of viewers may be regarded as corresponding, and may vary significantly and quickly with respect to the overall field-of-view. It may therefore be inefficient (in terms of bandwidth) and generally slow if such options were offered in the context of an event for which tiled streaming is generally being used, as the appropriate tile for each of a group of viewers wishing to take advantage of the “tracking” feature in question may change frequently or quickly, on account of the area-of-interest shared by some or all those viewers changing, not just in terms of its position with respect to the overall field-of view available but potentially also in terms of its size and shape with respect to the overall field-of view available. On account of this, content providers may offer such an option by way of one or more specific streams provided in addition to the normal overall stream or fixed-position tiled streams, with the specific stream being based on video content filmed separately by having a camera trained on the person or object being tracked, and providing the feed from that camera as a separate feed or media object.

A challenge not recognized by let alone resolved by the above techniques relates to scenarios where a more specific stream is provided for an area of interest within media content that is determined to be common to multiple viewers is itself variable (in the sense that it is not fixed in position, size and/or shape with respect to the overall media content.

### SUMMARY

According to a first aspect present disclosure, there is provided a method of providing media content to client devices configured to render received media content for displaying as a video presentation, the method comprising providing a primary stream to the client devices, the primary stream comprising data corresponding to a full area of the media content when displayed as a video presentation on a client device; receiving field-of-view reports from respective client devices, the or each field-of-view report from a client device indicating a portion of the full area identified as having been selected for viewing by a viewer of the media content via the client device; determining from the field-of-view reports at least one common area of interest within the media content, the common area of interest corresponding to a portion of the media content identified as having been selected for viewing by viewers of the media content via a plurality of the client devices; providing a supplementary stream to one or more of the client devices, the supplementary stream being configured to include a subset of the primary stream selected in dependence on the common area of interest determined from the received field-of-view reports; determining from the field-of-view reports whether the at least one common area of interest corresponds to a variable spatial area of the media content when displayed as a video presentation on the one or more client devices, and if so, providing as the supplementary stream to the one or more client devices, a supplementary stream comprising data corresponding to the variable spatial area.

According to embodiments, the primary stream is generally provided to a plurality of the client devices at least initially, and may be the default stream for some or all client devices unless or until it is determined that a supplementary stream is appropriate for the client device in question.

According to embodiments, the area of interest indicated in a field-of-view report received from a respective client device may be determined by the respective client device in respect of one or more viewers viewing content being displayed by the respective client device. This may be determined from the monitoring of one or more viewers viewing content being displayed by the respective client device, from user input received at the client device, or otherwise.

According to embodiments, analysis of a plurality of field-of-view reports from a client device may together indicate that a portion of the media content identified as having been selected for viewing by a viewer of the media content via the client device in question is a variable spatial area. It is however possible in an alternative embodiment that a field-of-view report from a client device may itself provide an indication that a portion of the media content identified as having been selected for viewing by a viewer of the media content via the client device in question is a variable spatial area.

According to embodiments, the variable spatial area of the media content to which the subset of the primary stream corresponds may be variable by virtue of the portion within the full area of the media content to which it corresponds being variable in position relative to the full area of the media content. The variable spatial area may thus appear as a moving or movable portion with respect to the full area of the media content, rather than a static portion such as a standard “tile”.

Alternatively or additionally, the variable spatial area of the media content to which the subset of the primary stream corresponds may be variable by virtue of the portion within the full area of the media content to which it corresponds being variable in size and/or shape.

According to embodiments, the primary stream may comprise media content which, when displayed as a video presentation on a client device, appears as video content at least partially surrounding a viewer viewing the video presentation on the client device.

It should be noted that while the term “360° video” may appear to suggest a form of video presentation that completely “surrounds” the viewer in two or three dimensions, it will be appreciated that this would generally require a display device that completely surrounds the viewer. In the context of embodiments of the present disclosure, that is not generally the case, and is generally unnecessary to provide the viewer with the impression of being surrounded by video content—embodiments aim to provide forms of video presentation that appear to the viewer as if they surround the viewer without requiring such a display device, generally by use of a screen, headset or other such display device that fills at least a significant portion of the possible field-of-vision of the viewer, with content being displayed on enough of the display device in question to fill at least a significant portion of the possible field-of-vision of the viewer even when the field-of-vision of a viewer changes due to head movement, eye-direction changes or otherwise.

According to embodiments, the portion of the full area indicated in a field-of-view report from a respective client device may indicate a spatial area of the media content being displayed as a video presentation on the respective client device. Alternatively or additionally, the portion of the full area indicated in a field-of-view report from a respective client device may indicate a location within a spatial area of the media content being displayed as a video presentation on the respective client device. This may be a location that has been determined to be a location at which a user's viewing is directed. This may be achieved using eye-tracking or other such direction-of-gaze tracking, by monitoring head-movements of the viewer, by monitoring selections made via a user-interface selection or using other selection mechanisms.

According to embodiments, the selected subset may be a region selected based on field-of-view reports from a plurality of the client devices.

According to embodiments, the method may further comprise multicasting the supplementary stream to a plurality of the client devices.

According to embodiments, the method may further comprise identifying from a field-of-view report from a respective client device whether the supplementary stream corresponds with or overlaps with a subset of the primary stream indicated in the field-of-view report as having been selected for viewing by a viewer of the media content via the client device, and if so, unicasting the supplementary stream to the respective client device.

According to embodiments, the method may involve providing descriptions of a plurality of supplementary streams for selection by a client device in dependence on a portion of the full area identified as having been selected for viewing by a viewer of the media content via the client device, then providing a selected supplementary stream.

According to embodiments, the method may involve providing a supplementary stream to a respective client device selected in dependence on one or more field-of-view reports received from the respective client device.

According to embodiments, the method may comprise providing one or more of a plurality of supplementary streams to respective client devices, the supplementary streams each being configured to include a subset of the primary stream selected in dependence on the common area of interest determined from the received field-of-view reports.

According to a second aspect present disclosure, there is provided apparatus for of providing media content to client devices configured to render received media content for displaying as a video presentation, the apparatus comprising: one or more interfaces configured to provide a primary stream to the client devices, the primary stream comprising data corresponding to a full area of the media content when displayed as a video presentation on a client device; the one or more interfaces further being configured to receive field-of-view reports from respective client devices, the or each field-of-view report from a client device indicating a portion of the full area identified as having been selected for viewing by a viewer of the media content via the client device; one or more processors configured to determine from the field-of-view reports at least one common area of interest within the media content, the common area of interest corresponding to a portion of the media content identified as having been selected for viewing by viewers of the media content via a plurality of the client devices; and the one or more interfaces further being configured to provide a supplementary stream to one or more of the client devices, the supplementary stream being configured to include a subset of the primary stream selected in dependence on the common area of interest determined from the received field-of-view reports; the apparatus further being configured to determine from the field-of-view reports whether the at least one common area of interest corresponds to a variable spatial area of the media content when displayed as a video presentation on the one or more client devices, and if so, to provide as the supplementary stream to the one or more client devices, a supplementary stream comprising data corresponding to the variable spatial area.

According to a third aspect of the present disclosure, there is provided a computer program element comprising computer program code to, when loaded into a computer system and executed thereon, cause the computer to perform the method according to the first aspect.

The various options and embodiments referred to above in relation to the first aspect are also applicable in relation to the second and third aspects.

Embodiments relate in particular to scenarios in which:
a live 360° video stream is being delivered to multiple receiving client devices;
there are one or more areas of interest within the overall stream which viewers (and hence their respective client devices) may be more likely to target with their respective fields-of-view;
client devices continuously report their viewer's field-of-view to a centralized controller; and
areas of interest may themselves be variable (in position, size, shape, etc.) rather than fixed with respect to the overall field-of view available (e.g. for “ball-tracking”, “player-cam” or other such options in televised sport).

According to embodiments, respective viewers' areas of interest are identified and their movements tracked by analysis of client device reports of their fields-of-view. Supplementary video streams corresponding to portions (i.e. those usually referred to as “tiles”, but it should be noted that one or more of them may itself be moving or otherwise variable with respect to the overall content) which are subsets of the overall video and correspond to the identified areas of interest are then offered to client devices, allowing individual devices to switch to a supplementary stream which matches or encompasses their own viewer's currently-chosen field-of-view. If the viewer's area of interest changes (as determined from field-of-view reports) (or if a dynamic tile moves such as to become or cease to be the tile corresponding best to viewer's currently-chosen field-of-view), such that a different supplementary stream becomes applicable for the viewer in question, the newly-applicable supplementary stream is instead offered to the client device in question.

Embodiments can reduce the bandwidth needed to deliver an appropriate video stream to the client device corresponding to the (in some cases dynamic) portion of the overall field-of-view that the viewer wishes to see, and improve user experience by allowing for rapid switching between the streams provided to respective client devices.

### BRIEF DESCRIPTION OF THE DRAWINGS

An embodiment of the present disclosure will now be described with reference to the appended drawings, in which:

FIG. 1 is a block diagram of a computer system suitable for the operation of embodiments of the present disclosure.

FIG. 2 shows the entities involved in performing a method according to an embodiment of the present disclosure.

FIG. 3 is a flow-chart illustrating how determinations may be made as to which stream is to be received at respective client devices according to an embodiment of the present disclosure.

FIG. 4 is a flow-chart illustrating how a method according to an embodiment of the present disclosure may be performed.

### DETAILED DESCRIPTION

With reference to the accompanying figures, methods and apparatus according to embodiments will be described.

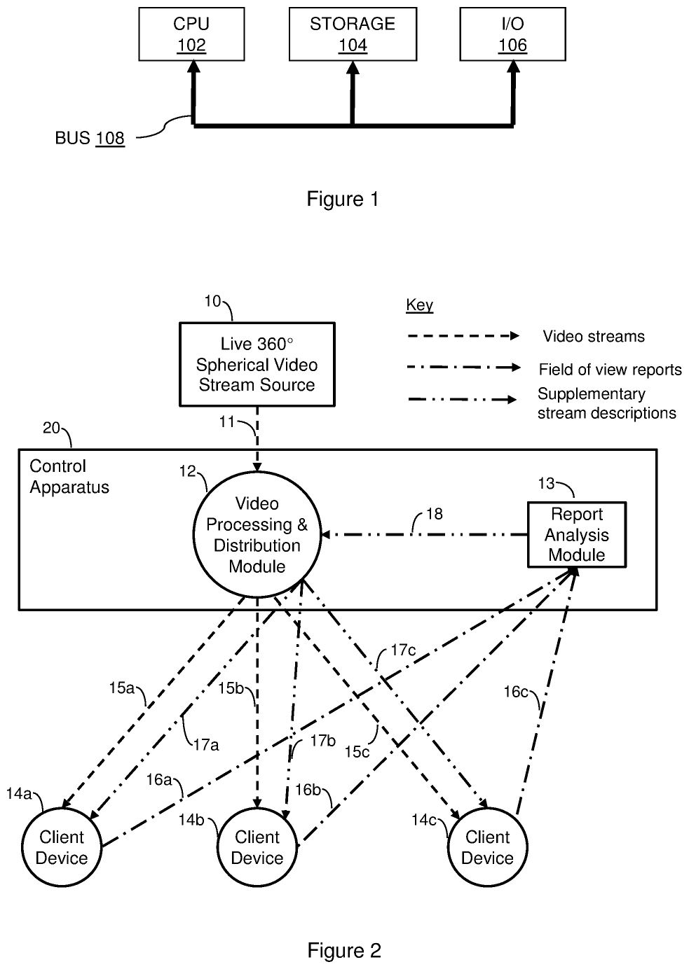

FIG. 1 is a block diagram of a computer system suitable for the operation of embodiments of the present disclosure. A central processor unit (CPU) 102 is communicatively connected to a data store 104 and an input/output (I/O) interface 106 via a data bus 108. The data store 104 can be any read/write storage device or combination of devices such as a random access memory (RAM) or a non-volatile storage device, and can be used for storing executable and/or non-executable data. Examples of non-volatile storage devices include disk or tape storage devices. The I/O interface 106 is an interface to devices for the input or output of data, or for both input and output of data. Examples of I/O devices connectable to I/O interface 106 include a keyboard, a mouse, a display (such as a monitor) and a network connection.

With reference to FIG. 2, the entities involved in the apparatus for performing an embodiment include a 360° spherical video stream source 10 which in an embodiment is providing live 360° content. This streams content to a video processing and distribution module 12 of a control apparatus 20 which receives the live 360° spherical video stream source as input 11, and provides, as outputs:
A live 360° video as per existing standards (such as using a single stream, or using tiled streaming)
One or more supplementary video streams which may correspond to static subsets of the overall live 360° video stream, but as will become apparent, may in correspond to moving subsets of the overall live 360° video stream. (NB Streams are said to “correspond” to subsets of the overall video stream in the sense that they comprise data which, if/when rendered and displayed on a client device, appear as the portion in question of the overall video stream if that were to be rendered and displayed.)

The number of streams and their coordinates at any time is set in an embodiment by a report analysis module 13 of the control apparatus 20, which may be separate from and remote from the video processing and distribution module 12, but as shown in FIG. 2, may be part of the same control apparatus 20. (NB The respective modules are shown symbolically as separate functional items in FIG. 2 mainly in order to assist in the explanation of the overall functionality of the control apparatus 20, but also to allow the various types of data exchange to be shown more clearly in FIG. 2 by respective arrows. They need not be separate physical modules.)

The video processing and distribution module 12 is in communication with the report analysis module 13 which continuously receives client device reports which specify the respective devices' current fields-of-view, and continuously outputs the number of supplementary video streams and their coordinates within the overall video stream. Multiple client devices 14a, 14b, 14c (generally, 14) receive and display the overall live 360° video stream or one of the supplementary streams for their respective viewers.

Initially, the overall 360° video stream may be provided to all client devices 14 by default, or other default behaviors may be configured, either centrally or on a device-by-device basis.

In an embodiment, the client devices 14 are devices such as networked digital media players (DMPs) and/or digital media renderers (DMRs) configured to receive, render (if required) and display received media content. The client devices 14 may comprise separate components or modules configured to perform the respective functions of receiving, rendering and playing received content.

The client devices 14 may have flat displays such as those of television screens, personal computers, smartphones or other mobile device on which the viewer may have control of the viewing direction or portion of the overall content that appears on the flat screen, or may have displays arranged in a sphere (or part of a sphere) around the viewer, or may be dedicated head-mounted displays or other such headsets which can be worn by viewers, for example. In each case, they are configured to detect on a continuous basis (i.e. based on repeated determinations of the portion of the overall content being selected or viewed by the respective viewers, using eye-tracking or monitoring of head-movements, for example) the current field-of-view being chosen by the viewer, and provide field-of-view reports to the report analysis module 13. As will be explained later, this is configured to process the field-of-view reports and provide to the video processing and distribution module 12 a “summary description” 18 comprising supplementary stream descriptions in respect of the/each supplementary stream that is currently available.

As will be apparent from the explanation below, the video streams (shown as dashed lines 15a, 15b, 15c (generally, 15)) delivered from the video processing and distribution module 12 to each of the client devices 14 are generally either the 360° video as per existing standards, or one of the supplementary video streams, depending on the respective client device's current field-of-view (although in some cases it is possible that one or more supplementary video streams may be delivered concurrently with the 360° video or each other, at least temporarily).

Generally, the client devices 14 are remote from the video processing and distribution module 12 and the report analysis module 13 (it will be appreciated that these may be co-located in control apparatus 20 as shown in FIG. 2, but could be remote from each other). In the general case where the devices 14 are not co-located with the modules 12, 13 of the control apparatus 20, distribution of the video streams 15 and associated metadata from the video processing and distribution module 12 to the client devices 14 and delivery of field-of-view reports (shown as single-dot, single-dash lines 16a, 16b, 16c (generally, 16)) from the client devices 14 to the report analysis module 13 are performed via a communications network (not shown) such as the internet.

### Report Analysis Module 13

In an embodiment, the report analysis module 13 infers the presence of areas of interest and tracks their movement by analyzing incoming client device field-of-view reports 16. The most recently reported field-of-view reports for each consuming client device 14 are aggregated into a spatial data structure where each point or small subset of the total spatial area is associated with the number of consuming client devices 14 whose fields-of-view overlap with the point or small area. Points or small areas of the spatial data structure where the determined number of overlapping fields-of-views of consuming client devices 14 is above a threshold value indicate areas of interest. A process such as this for inferring the presence of an area of interest from a set of field-of-view reports is described in the paper referred to above entitled “Analysis of 360° Video Viewing Behaviors”. The process may be repeated periodically as further field-of-view reports are received from consuming client devices 14. In the event that the presence of an area of interest is inferred in an iteration of the above process, and in the next iteration of the process an area of interest is inferred which is equal to or within a small spatial distance of the first area of interest, the area of interest may be assumed to have remained static or moved respectively.

The report analysis module 13 also determines the number of client devices 14 which are tracking the respective areas of interest by comparing the reported fields-of-view with the determined field-of-view of the respective area of interest.

For any areas of interest determined to have a (non-zero) number of consuming client devices 14 above a suitable threshold, a supplementary stream is created by the video processing and distribution module 12. This supplementary stream tracks the determined area of interest with a suitable spatial margin. This may be achieved by creation of a media stream which corresponds to a moving spatial subset of the primary media stream, where the spatial subset is continuously updated to a spatial area equal to the result of increasing the size of the determined field-of-view of the respective area of interest by a variable length margin in each direction. The use of a margin reduces the probability that the field-of-view of a consuming client device 14 tracking the area of interest will no longer be within the field-of-view of the supplementary stream due to imprecise tracking by the consuming client device 14. Consuming client devices 14 tracking a moving area of interest are unlikely to track moving areas of interests as precisely as static areas of interest, therefore the width of the margin is increased according to the current speed of motion of the area of interest. An analysis of the characteristics of motion of consuming client devices and a mechanism for determining a suitable margin width from the current speed and direction of motion of the area of interest are described in the paper entitled “Shooting a Moving Target: Motion-Prediction-Based Transmission for 360-Degree Videos” (referred to earlier). In the event that the number of consuming client devices for a particular supplementary stream falls to zero or falls below a suitable threshold, the supplementary stream may be removed.

A supplementary stream description in respect of the/each supplementary stream (generally specifying their number and coordinates, and possibly other information) is transmitted by the report analysis module 13 to the video processing and distribution module 12. In an embodiment, if there are plural supplementary stream descriptions, they are transmitted as a summary description 18 (shown as double-dot, single-dash line 18).

### Video Processing and Distribution Module 12

The summary description 18 of the supplementary stream(s) (setting out the number and coordinates of the/each supplementary stream) is received from the report analysis module 13, and one or more supplementary stream descriptions (17a, 17b, 17c (generally, 17)) are transmitted to the respective client devices 14 setting out the coordinates of the possible supplementary streams currently available. As will be appreciated, these coordinates are generally fixed for static “tiles”, but as will become apparent, they may be time-varying in the event that they relate to a supplementary stream in respect of a moving portion of the overall media content.

The supplementary streams are generated from the live 360° spherical video stream source input according to the received descriptions in the summary description 18. The overall 360° video stream is generated from the live 360° spherical video stream source input 11 as per existing standards.

### Client Devices 14

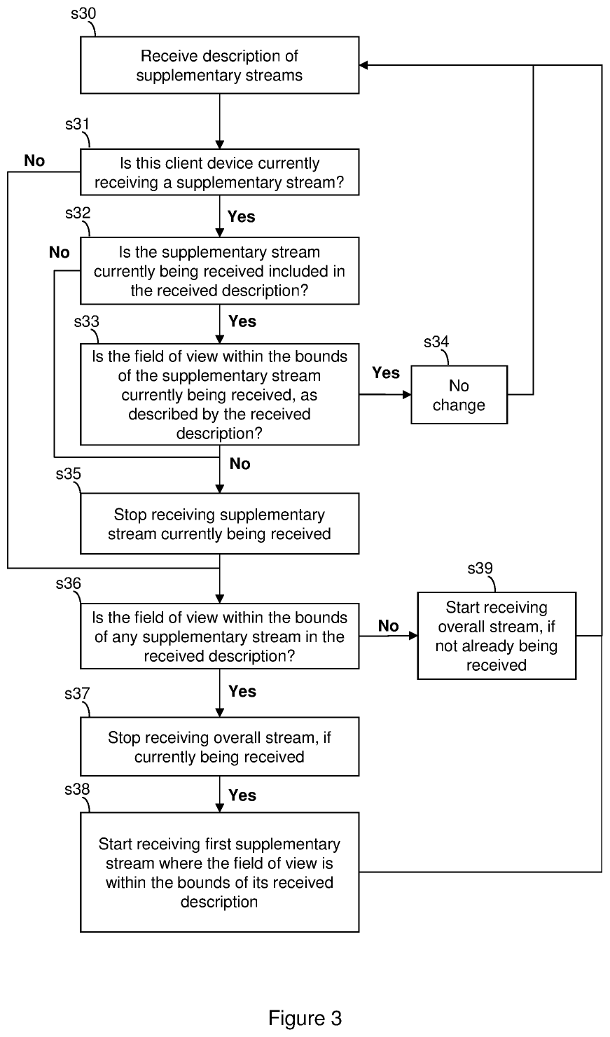

With reference to FIG. 3, the process by which entities such as those shown in FIG. 2 interact and determine which stream is to be provided to and used/displayed at a respective client device 14 according to an embodiment is described below. This process may be executed continuously by and in respect of each client device 14 as the updates to the description of supplementary streams are received and/or the field-of-view of the respective client device 14 changes.

At s30, the description of supplementary streams is received by each respective client device 14 from the video processing and distribution module 12.

At s31, it is determined whether the respective client device 14 is already receiving a supplementary stream. If not, the process proceeds directly to s36.

If the client device 14 is already receiving a supplementary stream, it is determined at s32 whether the supplementary stream that the client device is receiving is still within the received description of the supplementary stream. If not, the supplementary stream is no longer available and the process proceeds directly to s35.

If the supplementary stream that the client device is receiving is still within the description of supplementary streams, it is determined at s33 whether the client device's field-of-view is within the bounds of the supplementary stream that the client device is receiving, as indicated by the description of supplementary streams. If so, the process proceeds to s34. If not, the process proceeds directly to s35.

At s34, no change is required if the currently received supplementary stream is still present and contains the client device's field-of-view. The process can then return to s30 from which the process may be repeated.

At s35, if the supplementary stream that the client device has been receiving is no longer usable, the client device stops receiving it.

At s36, it is determined whether any of the supplementary streams listed in the description of supplementary streams wholly contains the client device's current field-of-view. If so, the process proceeds to s37. If not, the process proceeds to s39.

At s37, if a suitable supplementary stream is available, the client device stops receiving the overall stream if that is currently being received. At s38, if a suitable supplementary stream is available, the client device starts receiving that supplementary stream.

The process can then return to s30 and be repeated on a continuous basis, ending when the streaming process in question terminates or when the client device in question stops receiving, for example.

If it has been found at s36 that none of the supplementary streams listed in the description of supplementary streams wholly contains or corresponds appropriately to the client device's current field-of-view, the process proceeds to s39.

At s39, since no suitable supplementary stream is available, the client device starts receiving the overall stream if that is not currently being received. The process can then return to s30 from which the process may be repeated.

It will be understood that respective supplementary video streams may be separate projections of a subset of the view-sphere centered on the associated area of interest, instead of a subset of the overall projection. This may be used to optimize the video quality relative to the bandwidth required of the supplementary stream by avoiding distortions associated with the projection of the entire view sphere onto a rectangular plane, which would otherwise be included in the supplementary stream.

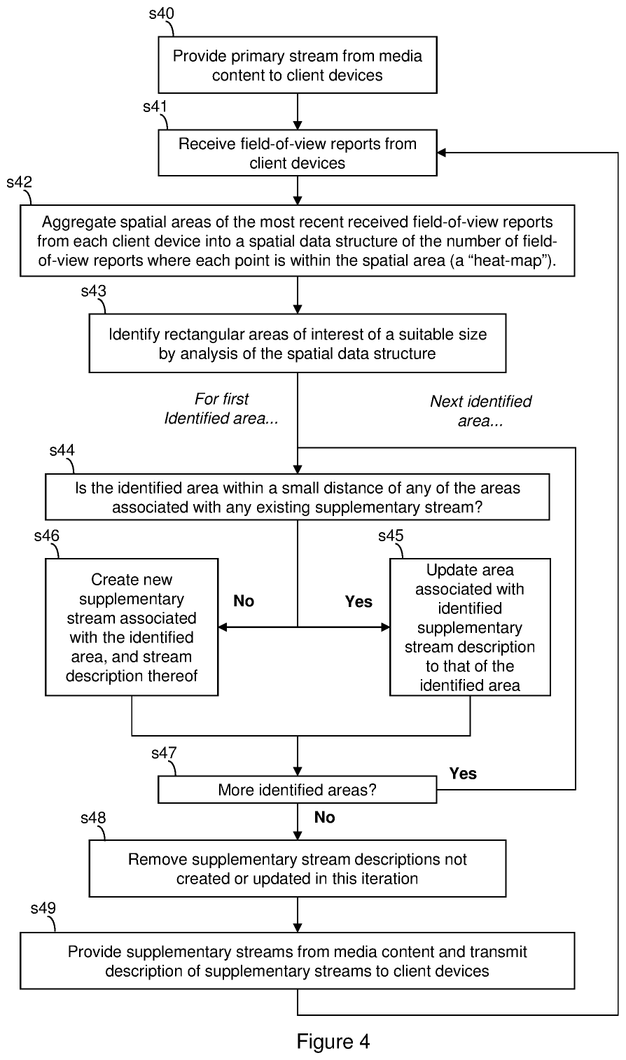

With reference now to FIG. 4, the process by which it is determined which stream is to be provided from the control apparatus 20 to respective client devices 14 according to an embodiment is described below. This process may be executed by apparatus such as the control apparatus 20 shown in FIG. 2, which may comprise modules such as the report analysis module 13 operating in conjunction with the video processing and distribution module 12. The process may be performed continuously in respect of the client devices 14 (for the duration of a streamed event, for example), in response to the receipt of field-of-view therefrom, or in response to the field-of-view report from a particular client device changing, or otherwise.

At s40, the primary media stream (generally data corresponding to the overall media content) is provided to client devices 14.

At s41, field-of-view reports 16 are received from client devices 14.

At s42, the set of field-of-view reports 14 most recently received from each client device 14 is aggregated into a data structure which maps each spatial point to the number of field-of-view reports where the spatial point is inside the spatial area indicated in the report (this may be referred to as a “heat-map”).

At s43, rectangular areas of interest of a suitable size are identified by analysis of the data structure, where the criteria for an area to be of interest is that the average of the number of field-of-view reports per point within the areas is above a suitable (generally non-zero) threshold.

S44 to s47 are executed for each identified area of interest.

At s44, the identified area of interest is compared with the area associated with each supplementary stream descriptor in the description of supplementary streams 17. If the identified area of interest is within a small spatial distance of the area associated with a supplementary stream descriptor (or matches any of them exactly), this indicates that the identified area of interest is a continuation in time of the existing supplementary stream, and the process proceeds to s45. Otherwise the process proceeds to s46.

At s45, the area associated with the identified supplementary stream descriptor is modified to be equal to the identified area of interest (if not already equal). The area associated with the supplementary stream descriptor may thus move with respect to time according to changes in the distribution of field-of-view reports with respect to time, or remain static. The process proceeds to s47.

At s46, since the identified area of interest is not within a small spatial distance of the area associated with any existing supplementary stream descriptor, a new supplementary stream descriptor is created (with an associated descriptor) with its associated area equal to the identified area of interest. The new supplementary stream descriptor is added to the description of supplementary streams.

At s47, if identified areas of interest are remaining, the process returns to s44 with the next identified area of interest, otherwise the process proceeds to s48.

At s48, supplementary stream descriptors in the description of supplementary streams which were neither created nor updated by s46 or s45 respectively in the current iteration of the process are removed. Supplementary stream descriptors are thus removed when the distribution of field-of-view reports no longer indicates that the area associated with the supplementary stream descriptor is of interest.

At s49, the description of supplementary streams is transmitted to all client devices, and the supplementary streams are provided to client devices by the video processing and distribution module 12 in accordance with the description of supplementary streams.

The process then returns to s41 to begin the next iteration of the process.

By virtue of the above process, an embodiment is able to provide one or more supplementary streams each corresponding to a portion of the overall media content that may be static but may also be variable (generally in its position, but also possibly in terms of its size and/or shape) with respect to the overall media content when displayed on client devices, doing so when field-of-view reports from respective client devices indicate that there is a common area of interest that is itself variable (in position, size and/or shape).

Insofar as embodiments of the present disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the present disclosure is not limited thereto and that there are many possible variations and modifications which fall within the scope of the present disclosure.

The scope of the present disclosure may include other novel features or combinations of features disclosed herein. The applicant hereby gives notice that new claims may be formulated to such features or combinations of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A method of providing media content to client devices configured to render received media content for displaying as a video presentation, the method comprising:
providing a primary stream to the client devices, the primary stream comprising data corresponding to a full area of the media content when displayed as a video presentation on a client device;
receiving at least one field-of-view report from at least one client device, the at least one field-of-view report from the at least one client device indicating a portion of the full area identified as having been selected for viewing by a viewer of the media content via the at least one client device;
determining from the at least one field-of-view report at least one common area of interest within the media content, the common area of interest corresponding to a portion of the media content identified as having been selected for viewing by viewers of the media content via a plurality of the client devices;
providing a supplementary stream to one or more of the client devices, the supplementary stream being configured to include a subset of the primary stream selected in dependence on the common area of interest determined from the received field-of-view reports; and
determining from the field-of-view reports whether the at least one common area of interest corresponds to a variable spatial area of the media content when displayed as a video presentation on the one or more client devices, and if so, providing as the supplementary stream to the one or more client devices, a supplementary stream comprising data corresponding to the variable spatial area.

2. The method according to claim 1, wherein the variable spatial area of the media content to which the subset of the primary stream corresponds is variable by virtue of the portion within the full area of the media content to which the variable spatial area of the media content corresponds being variable in position relative to the full area of the media content.

3. The method according to claim 1, wherein the variable spatial area of the media content to which the subset of the primary stream corresponds is variable by virtue of the portion within the full area of the media content to which the variable spatial area of the media content corresponds being variable in at least one of size or shape.

4. The method according to claim 1, wherein the primary stream comprises media content which, when displayed as a video presentation on a client device, appears as video content at least partially surrounding a viewer viewing the video presentation on the client device.

5. The method according to claim 1, wherein the portion of the full area indicated in a field-of-view report from a respective client device indicates a spatial area of the media content being displayed as a video presentation on the respective client device.

6. The method according to claim 1, wherein the portion of the full area indicated in a field-of-view report from a respective client device indicates a location within a spatial area of the media content being displayed as a video presentation on the respective client device.

7. The method according to claim 5, wherein the portion of the full area indicated in a field-of-view report from a respective client device is determined by monitoring where viewing by a user is directed.

8. The method according to claim 1, wherein the selected subset is a region selected based on field-of-view reports from a plurality of the client devices.

9. The method according to claim 1, further comprising multicasting the supplementary stream to a plurality of the client devices.

10. The method according to claim 1, further comprising identifying from a field-of-view report from a respective client device whether the supplementary stream corresponds with or overlaps with a subset of the primary stream indicated in the field-of-view report as having been selected for viewing by a viewer of the media content via the client device, and if so, unicasting the supplementary stream to the respective client device.

11. The method according to claim 1, further comprising providing descriptions of a plurality of supplementary streams for selection by a client device in dependence on a portion of the full area identified as having been selected for viewing by a viewer of the media content via the client device, then providing a selected supplementary stream.

12. The method according to claim 1, further comprising providing a supplementary stream to a respective client device selected in dependence on one or more field-of-view reports received from the respective client device.

13. The method according to claim 1, further comprising providing one or more of a plurality of supplementary streams to respective client devices, the supplementary streams each being configured to include a subset of the primary stream selected in dependence on the common area of interest determined from the received field-of-view reports.

14. An apparatus for of providing media content to client devices configured to render received media content for displaying as a video presentation, the apparatus comprising:
one or more interfaces configured to provide a primary stream to the client devices, the primary stream comprising data corresponding to a full area of the media content when displayed as a video presentation on a client device, the one or more interfaces further being configured to receive at least one field-of-view report from at least one client device, the at least one field-of-view report from the at least one client device indicating a portion of the full area identified as having been selected for viewing by a viewer of the media content via the client device;
one or more processors configured to determine from the at least one field-of-view view report at least one common area of interest within the media content, the common area of interest corresponding to a portion of the media content identified as having been selected for viewing by viewers of the media content via a plurality of the client devices;
wherein the one or more interfaces are further configured to provide a supplementary stream to one or more of the client devices, the supplementary stream being configured to include a subset of the primary stream selected in dependence on the common area of interest determined from the received field-of-view reports;
and wherein the apparatus is configured to determine from the at least one field-of-view report whether the at least one common area of interest corresponds to a variable spatial area of the media content when displayed as a video presentation on the one or more client devices, and if so, to provide as the supplementary stream to the one or more client devices, a supplementary stream comprising data corresponding to the variable spatial area.

15. A non-transitory computer-readable storage medium storing a computer program element comprising computer program code to, when loaded into a computer system and executed thereon, cause the computer system to perform the method of claim 1.
